(19) United States
(12) Patent Application Publication
(10) Pub. No.: US 2008/0029197 A1
(43) Pub. Date: Feb. 7, 2008

(54) SURFACE TREATING APPARATUS USING ATOMIC HYDROGEN

(75) Inventors: Hiroshi Haji, Fukuoka (JP); Kiyoshi Arita, Fukuoka (JP); Isamu Morisako, Fukuoka (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/772,435

(22) Filed: Jul. 2, 2007

(30) Foreign Application Priority Data
Jul. 4, 2006 (JP) P. 2006-184055
Jul. 4, 2006 (JP) P. 2006-184056

(51) Int. Cl. B31B 1/60

(52) U.S. Cl. 156/1

(57) ABSTRACT

In a surface treating apparatus using atomic hydrogen for causing atomic hydrogen to come in contact with a treating object 5 such as a substrate accommodated in a treating chamber 3, thereby carrying out a surface treatment, an atomic hydrogen generator 11 having the function of generating the atomic hydrogen by causing a hydrogen gas to come in contact with a tungsten heater incorporated into a heater cassette 12 in a generating chamber 21a, and the treating chamber 3 can communicate with each other through an opening portion 2c for introduction, and the opening portion 2c for introduction is constituted to be freely opened and closed by means of a shutter member 7. Consequently, it is possible to maintain the generating chamber 21a into a pressure reducing state irrespective of the state of the treating chamber 3, thereby eliminating a waiting time for raising a temperature of the tungsten heater and cooling the tungsten heater. Accordingly, it is possible to enhance a treatment efficiency in an atomic hydrogen treatment.

### BACKGROUND OF THE INVENTION

The present invention relates to a surface treating apparatus using atomic hydrogen for causing atomic hydrogen to come in contact with a treating object to carry out a surface treatment over the treating object.

In the field for manufacturing an electronic component of a semiconductor apparatus, there has conventionally been known a technique for applying an activating action of atomic hydrogen to a surface treatment to be performed for removing an oxide film or an organic substance which is generated on a surface of a substrate (for example, see Patent Documents 1 and 2). In an example shown in the Patent Document 1, the atomic hydrogen is caused to act on an oxide film generated on a surface of a semiconductor substrate, thereby reducing and removing the oxide film. In an example shown in the Patent Document 2, moreover, a resist formed on the surface of the semiconductor substrate and the atomic hydrogen are caused to act to each other so that the resist is peeled on a vapor phase basis.

Also in both of the examples in the Patent Documents, atomic hydrogen generated by causing a hydrogen gas to come in contact with a heat generator capable of carrying out high temperature heating, for example, a tungsten heater is caused to act on a treating object accommodated in a vacuum container. In the example of the Patent Document 1, a hydrogen gas housing container for generating atomic hydrogen and a heat generator formed of tungsten are provided separately from the vacuum container. In the example of the Patent Document 2, there has been disclosed a structure in which a heat generator is directly disposed in a vacuum chamber.

[Patent Document 1] JP-A-3-263830 Publication

[Patent Document 2] JP-A-2002-289586 Publication

However, the examples of the prior art shown in the Patent Documents have the following problem as to a practical treating apparatus for efficiently executing a surface treatment through the atomic hydrogen. More specifically, the treatment using the atomic hydrogen is carried out under a reduced pressure. For this reason, there is employed a batch processing configuration for delivering the treating object in/out of a treating chamber in which a pressure can be reduced every treating lot. After the pressure in the treating chamber is reduced to a predetermined treating pressure, the atomic hydrogen is caused to act on the treating object.

In this case, referring to the example described in the Patent Document 1, the atomic hydrogen generated in the hydrogen gas housing container provided separately is discharged into the treating chamber. Referring to the example described in the Patent Document 2, moreover, the heat generator is heated, and at the same time, a hydrogen gas is supplied into the treating chamber, thereby generating the atomic hydrogen in the treating chamber. Although a heater formed of tungsten which is used as the heat generator is excellent in a heat resistance, it is considerably deteriorated when heat is generated in the air up to a necessary high temperature for generating the atomic hydrogen (for example, 800° C. more). For this reason, the generation of the heat cannot be started before a reduction in the pressure is completed in the treating chamber at the start of the treatment. For the same reason, the inner part of the treating chamber cannot be returned to a have a normal pressure before a temperature of the heat generator is dropped at the end of the treatment.

For this reason, a cycle time in a process for repeating the treatment through the atomic hydrogen is to be a time obtained by adding, in series, a delivery processing time for exchanging the treating object and a temperature regulating time for raising the temperature of the heat generator to a predetermined time and cooling the heat generator to a normal temperature. Thus, a reduction in the cycle time is greatly restricted. Consequently, the atomic hydrogen treatment for causing the atomic hydrogen to come in contact with the treating object to carry out the surface treatment has conventionally had a problem in that the cycle time of the treatment is delayed and a treatment efficiency is thus hard to enhance.

In the examples of the prior art described in the Patent Documents, moreover, the apparatus for generating atomic hydrogen has such a structure that the heater formed of tungsten is simply incorporated in the vacuum container. For this reason, a maintenance property such as an exchange of the heater is not taken into consideration so that a usability is not always excellent. More specifically, in the process for repeating the atomic hydrogen treatment at a high frequency, the heater repeats the generation of heat and the cooling at a high frequency. Depending on use, therefore, it is necessary to exchange the apparatus for a new apparatus every time a lifetime is exceeded. For this reason, there has been demanded an atomic hydrogen generator which can easily be handled in a maintenance such as an exchange of a heater and is excellent in a general purpose.

### SUMMARY OF THE INVENTION

Therefore, it is an object of the invention to provide a surface treating apparatus using atomic hydrogen capable of enhancing a treatment efficiency in an atomic hydrogen treatment.

Moreover, it is an object of the invention to provide an atomic hydrogen generator which can easily be handled and is excellent in a general purpose.

The invention provides a surface treating apparatus using atomic hydrogen for causing atomic hydrogen to come in contact with a treating object, thereby carrying out a surface treatment for the treating object, comprising a treating chamber for accommodating the treating object, an atomic hydrogen generator having a generating chamber provided to be commutable with the treating chamber and serving to cause a hydrogen gas to come in contact with a heat generator in the generating chamber, thereby generating atomic hydrogen, a hydrogen gas supply for supplying the hydrogen gas to the generating chamber, opening and closing means for opening and closing a communicating port between the treating chamber and the generating chamber, an evacuator for individually reducing pressures in the treating chamber and the generating chamber, and a controller for controlling the heat generator, the opening and closing means, and the evacuator.

In the surface treating apparatus using atomic hydrogen according to the invention, the atomic hydrogen generator is constituted by a container having the generating chamber therein and including an exhaust port for connecting the generating chamber to the evacuator, a gas introducing port for connecting the generating chamber to the hydrogen gas supply, an atomic hydrogen discharging port for feeding the atomic hydrogen generated in the generating chamber to the treating chamber, and a connecting portion for connecting the atomic hydrogen discharging port to the communicating port in a vacuum tightness, and

a heat generator attached removably to an inner part of the generating chamber and serving to generate the atomic hydrogen from the hydrogen gas by causing the hydrogen gas to come in contact therewith in a heat generating state.

According to the invention, the treating chamber for accommodating the treating object and the generating chamber provided to be commutable therewith and serving to cause the hydrogen gas to come in contact with the heat generator which is built in, thereby generating the atomic hydrogen are freely opened and closed by the opening and closing means. Consequently, it is possible to maintain the generating chamber in a pressure reducing state irrespective of the state of the treating chamber, thereby eliminating a waiting time for raising the temperature of the heat generator and cooling the heat generator. Accordingly, it is possible to enhance a treatment efficiency in the atomic hydrogen treatment.

According to the invention, there is employed a structure in which the heat generator for generating the atomic hydrogen from the hydrogen gas by causing the hydrogen gas in the heat generating state to come in contact with the container including the generating chamber for generating the atomic hydrogen is attached removably. Consequently, it is possible to implement an atomic hydrogen generator which can easily be handled and is excellent in a general purpose.

### BRIEF DESCRIPTION OF THE DRAWINGS

FIG. 1 is a sectional view showing a surface treating apparatus using atomic hydrogen according to an embodiment of the invention,

FIG. 2 is a block diagram showing a structure of a control system of the surface treating apparatus using atomic hydrogen according to the embodiment of the invention,

FIG. 3 is a sectional view showing an atomic hydrogen generator to be used in the surface treating apparatus using atomic hydrogen according to the embodiment of the invention,

FIG. 4 is an exploded sectional view showing the atomic hydrogen generator to be used in the surface treating apparatus using atomic hydrogen according to the embodiment of the invention,

FIG. 5(a) is a perspective view showing the atomic hydrogen generator to be used in the surface treating apparatus using atomic hydrogen according to the embodiment of the invention and FIG. 5(b) is a perspective view showing a heater cassette of the atomic hydrogen generator according to the embodiment of the invention,

FIG. 6 is a perspective view showing the atomic hydrogen generator to be used in the surface treating apparatus using atomic hydrogen according to the embodiment of the invention,

FIG. 7 is a sectional view showing the surface treating apparatus using atomic hydrogen according to the embodiment of the invention,

FIG. 8 is a flowchart showing a drive preparing operation in the surface treating apparatus using atomic hydrogen according to the embodiment of the invention,

FIG. 9 is a flowchart showing a treating operation in the surface treating apparatus using atomic hydrogen according to the embodiment of the invention, and

FIG. 10 is a flowchart showing a drive stopping operation in the surface treating apparatus using atomic hydrogen according to the embodiment of the invention.

### DETAILED DESCRIPTION OF THE PREFERRED EMBODIMENTS

Next, an embodiment according to the invention will be described with reference to the drawings.

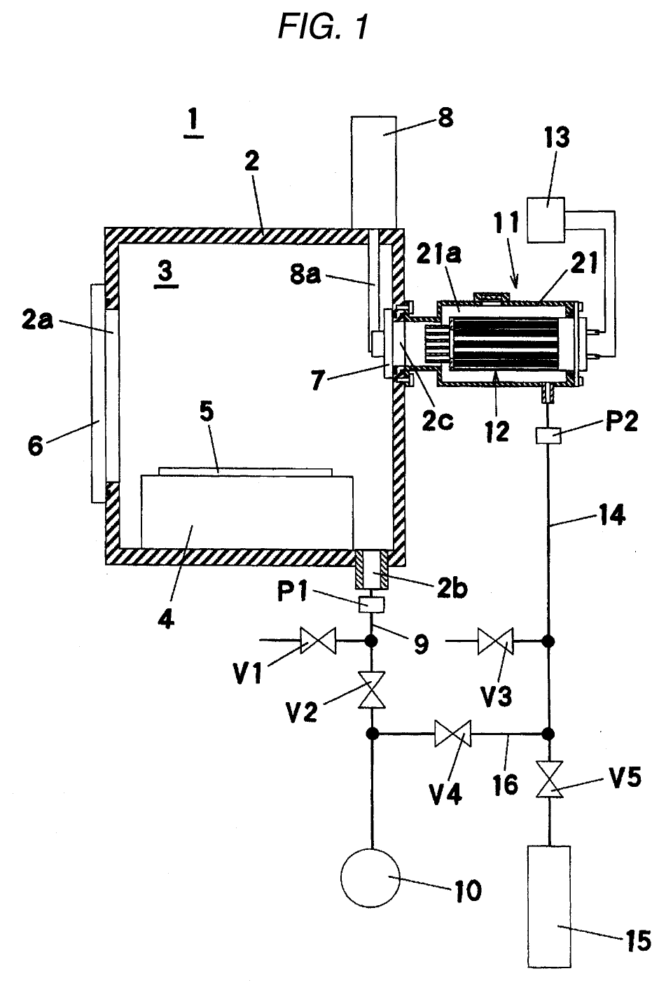

First of all, the structure of a surface treating apparatus using atomic hydrogen 1 will be described with reference to FIG. 1. The surface treating apparatus using atomic hydrogen 1 has the function of causing atomic hydrogen to come in contact with a treating object such as a resin substrate to be used in a semiconductor apparatus, thereby carrying out a surface treatment such as a surface modification. In FIG. 1, a vacuum chamber 2 is a closed container which is almost box-shaped, and a treating chamber 3 for accommodating the treating object to cause the atomic hydrogen to act is formed in the vacuum chamber 2. A mounting table 4 for mounting a treating object 5 such as a substrate in a horizontal posture is provided in the treating chamber 3. As a method of accommodating and holding the treating object 5 in the treating chamber 3, it is also possible to use a holding tool for holding the treating object 5 in a longitudinal posture or a suspending tool jig for holding the treating object 5 in a suspending posture depending on the characteristic and shape thereof.

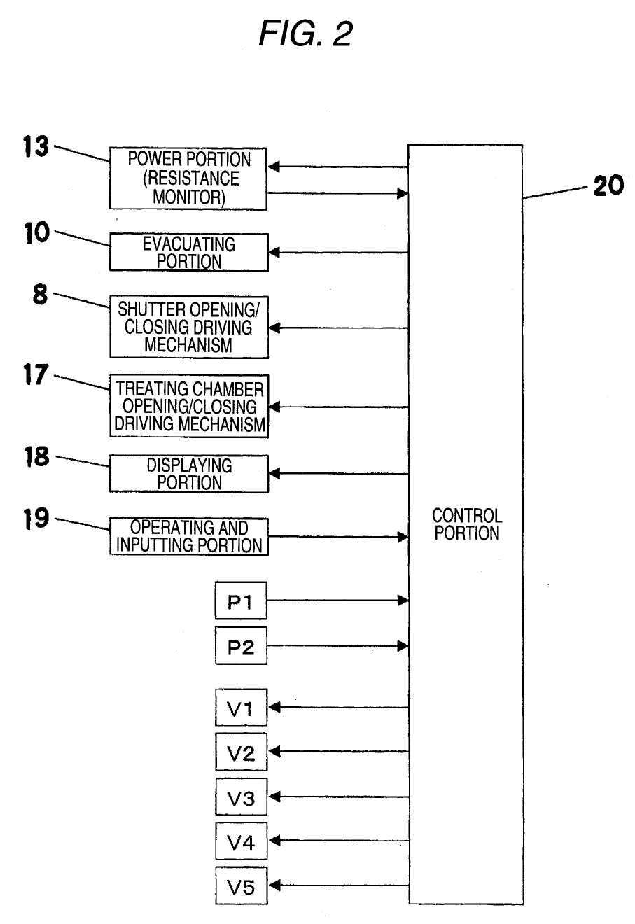

An opening portion 2a for delivering the treating object 5 in/out is provided on a side surface of the vacuum chamber 2. The opening portion 2a for delivery is freely opened and closed by a door member 6 to be driven by a treating chamber opening/closing driving mechanism (which is not shown in FIG. 1 . . . see a treating chamber opening/closing driving mechanism 17 shown in FIG. 2). The treating object 5 is delivered into the treating chamber 3 through the opening portion 2a for delivery in an opening state and is mounted on the mounting table 4. When the door member 6 is closed, the treating chamber 3 is brought into a closing state. In this state, an atomic hydrogen treatment is carried out. The treating object 5 subjected to the treatment is delivered out of the opening 2a for delivery.

An opening portion 2b for air intake and exhaust is provided on a bottom face of the vacuum chamber 2. A conduit 9 connected to the opening portion 2b for air intake and exhaust is connected to an evacuator 10 through a pressure sensor P1 and a treating chamber exhaust valve V2. Furthermore, the conduit 9 is provided with a treating chamber vent valve V1 which is branched between the pressure sensor P1 and the treating chamber exhaust valve V2. When the evacuator 10 is driven in a state in which the treating chamber exhaust valve V2 is opened, the treating chamber 3 is evacuated through the conduit 9 and the opening portion 2b for air intake and exhaust so that a space decompressed for the atomic hydrogen treatment is formed. When the treating chamber vent valve V1 is opened, the air is introduced into the treating chamber 3 through the conduit 9 and the opening portion 2b for air intake and exhaust. Consequently, the treating chamber 3 is returned to have a normal pressure. In the air intake and exhaust operation to/from the inner part of the treating chamber 3, the pressure sensor P1 detects a pressure in the treating chamber 3 and outputs a detection signal to a controller 20 shown in FIG. 2.

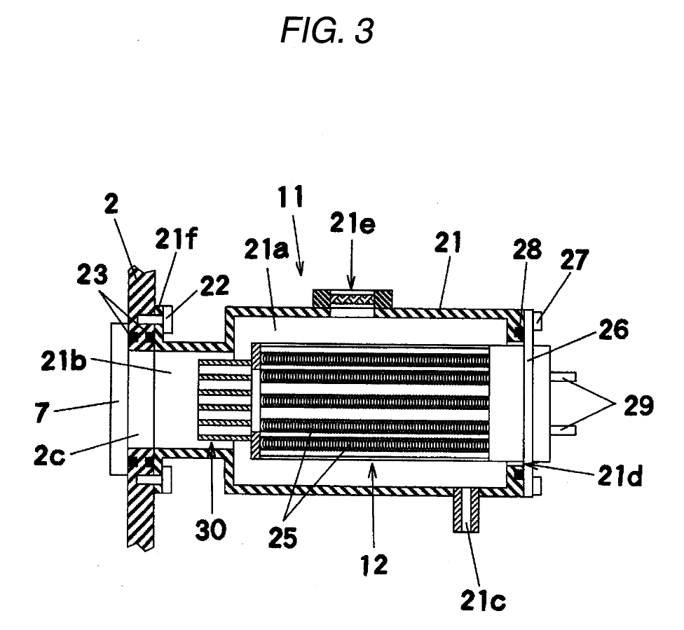

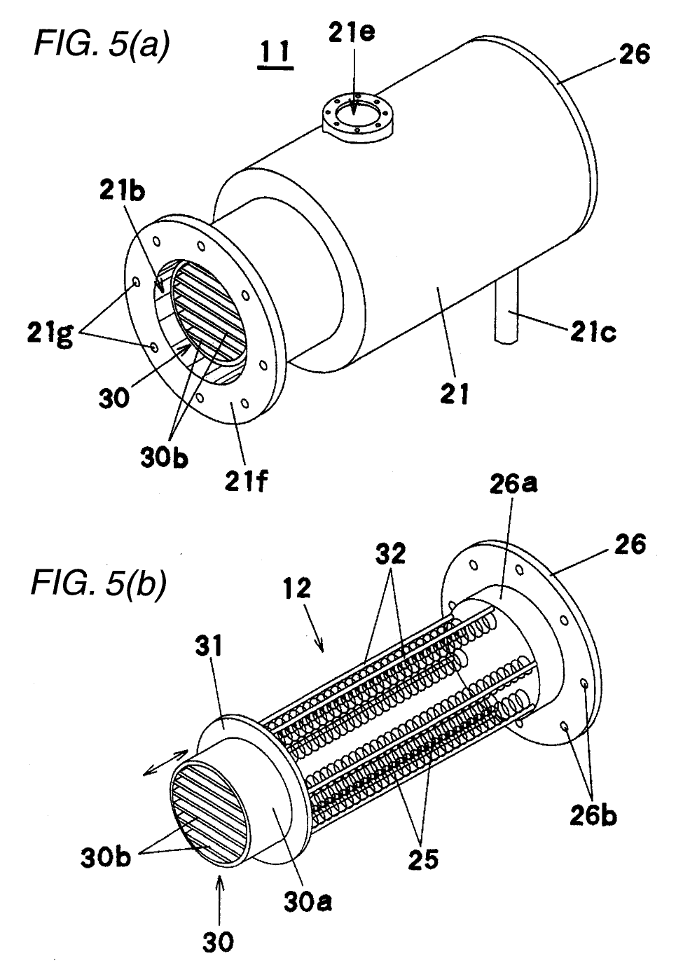

A side surface of the vacuum chamber 2 is provided with an opening portion 2c for introducing atomic hydrogen, and an atomic hydrogen generator 11 is connected to the opening portion 2c for introduction. The atomic hydrogen generator 11 mainly includes an almost cylindrical container 21 (see FIG. 5(a)), and a generating chamber (see a generating chamber 21a shown in FIG. 3) for communicating with the treating chamber 3 through the opening portion 2c for introduction is provided in the container 21. A hydrogen gas is caused to come in contact with a tungsten heater to be a heat generator provided in a heater cassette 12 in the generating chamber 21a so that atomic hydrogen which is electrically neutral and has an activating function is generated. More specifically, the atomic hydrogen generator 11 has such a structure that the generating chamber 21a is provided to be commutable with the treating chamber 3 and the hydrogen gas is caused to come in contact with the heat generator in the generating chamber 21a, thereby generating the atomic hydrogen.

The opening portion 2c for introduction takes such a shape as to be freely blocked by a shutter member 7, and the shutter member 7 is connected to a shutter opening/closing driving mechanism 8 through a connecting rod 8a. When the shutter opening/closing driving mechanism 8 is driven in an opening direction (an upward direction in FIG. 1) to open the opening portion 2c, the generating chamber 21a and the treating chamber 3 can be caused to communicate with each other. Consequently, the atomic hydrogen is discharged into the treating chamber 3. When the shutter opening/closing driving mechanism 8 is driven in a closing direction (a downward direction in FIG. 1) to close the opening portion 2c, the communicating state of the generating chamber and the treating chamber 3 is blocked so that the discharge of the atomic hydrogen into the treating chamber 3 is stopped. Accordingly, the shutter opening/closing driving mechanism 8, the connecting rod 8a and the shutter member 7 are opening and closing means for opening and closing the opening portion 2c for introducing the atomic hydrogen which serves as a communicating port between the treating chamber 3 and the generating chamber of the atomic hydrogen generator 11.

A conduit 14 is connected to the atomic hydrogen generator 11 through a pressure sensor P2, and furthermore, is connected to a hydrogen gas supply 15 through a hydrogen gas supply valve V5. The conduit 14 is coupled to the conduit 9 via a conduit 16 through a generating chamber exhaust valve V4, and furthermore, is provided with a generating chamber vent valve V3 which is branched on this side of the hydrogen gas supply valve V5. When the generating chamber exhaust valve V4 is opened to drive the evacuator 10 in a state in which the hydrogen gas supply valve V5 is closed, the generating chamber 21a is evacuated. More specifically, in the structure, the treating chamber 3 and the generating chamber 21a can be individually evacuated by means of the common evacuator 10.

By opening the generating chamber vent valve V3, moreover, it is possible to introduce the air into the generating chamber 21a, thereby carrying out a return to have a normal pressure. When the hydrogen gas supply valve V5 is opened in the state in which the generating chamber exhaust valve V4 is closed, the hydrogen gas is supplied from the hydrogen gas supply 15 into the generating chamber 21a of the atomic hydrogen generator 11 through the conduit 14. For a gas to be supplied from the hydrogen gas supply 15, the hydrogen gas or a gas obtained by diluting the hydrogen gas with an inert gas such as helium is used.

With reference to FIG. 2, next, description will be given to the structure of the control system. In FIG. 2, the controller 20 controls a power supply 13 for causing a tungsten heater 25 of the heater cassette 12 attached to the atomic hydrogen generator 11 to generate heat, the evacuator 10, the shutter opening/closing driving mechanism 8 and the treating chamber opening/closing driving mechanism 17. A resistance monitor signal is transmitted from the power supply 13 to the controller 20. Consequently, the generation of heat of the tungsten heater 25 is controlled. A display 18 is a display device such as a liquid crystal panel and serves to display an operating state of the power supply 13 and a guide screen in an input of an operation. An operating and inputting portion 19 is input means such as a touch panel or a keyboard and can manually give a command for an operation for driving a mechanism such as the shutter opening/closing driving mechanism 8 or the treating chamber opening/closing driving mechanism 17 and an operation for opening and closing each of the valves V1 to V5.

Pressure detection signals are fetched from the pressure sensors P1 and P2 to the controller 20. The signals are used as operation condition signals in a drive preparing operation and a treating operation. Moreover, the controller 20 controls an operation for opening and closing the treating chamber vent valve V1, the treating chamber exhaust valve V2, the generating chamber vent valve V3, the generating chamber exhaust valve V4 and the hydrogen gas supply valve V5. An operation program for controlling various operations is stored in the controller 20. The controller 20 controls each of the portions shown in FIG. 2 in accordance with an operation program so that the drive preparing operation and the processing operation which will be described below are executed automatically.

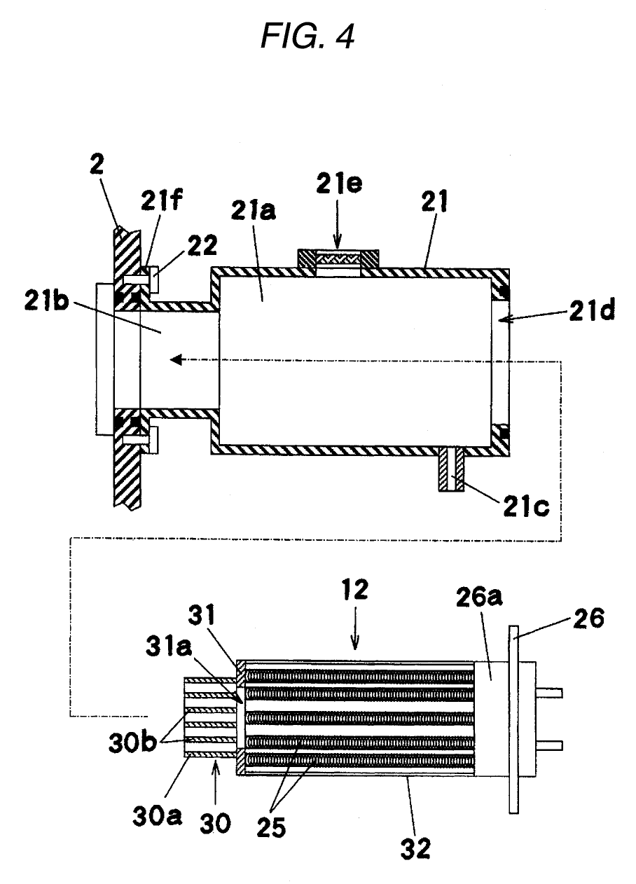

With reference to FIGS. 3, 4 and 5, next, description will be given to the detailed structure of the atomic hydrogen generator 11 for generating the atomic hydrogen from the hydrogen gas supplied from the hydrogen gas supply 15. As shown in FIGS. 3 and 4, the atomic hydrogen generator 11 has such a structure that the heater cassette 12 incorporating the tungsten heater 25 to be the heat generator is exchangeably attached to the generating chamber 21a formed in the container 21 taking an almost cylindrical shape which constitutes a body. The container 21 includes the generating chamber 21a for generating the atomic hydrogen by causing the introduced hydrogen gas to come in contact with the tungsten heater 25 which generates heat, and an atomic hydrogen discharging port 21b communicating with the generating chamber 21a and connected to the opening portion 2c for introduction in the vacuum chamber 2.

Furthermore, the container 21 is provided with a supply and exhaust port 21c connected to the conduit 14 and serving as an exhaust port for reducing a pressure and a gas introducing port for introducing the hydrogen gas, and a cassette inserting port 21d for attaching the heater cassette 12. The heater cassette 12 is inserted from the cassette inserting port 21d provided on a side end face of the container 21 and a disc-shaped attaching member 26 is fixed to the side end face of the container 21 with a bolt 27 so that the heater cassette 12 is attached to the atomic hydrogen generator 11.

A connecting flange 21f (see FIG. 5(a)) for a connection to the vacuum chamber 2 is provided on an end of the atomic hydrogen discharging port 21b, and the atomic hydrogen generator 11 is fastened to the side surface of the vacuum chamber 2 with a bolt 22 by using a fastening bolt hole 21g provided on the connecting flange 21f. When the opening portion 2c for introducing the atomic hydrogen is opened and closed by means of the shutter member 7, the opening portion 2c for introducing the atomic hydrogen which serves as the communicating port of the treating chamber 3 and the generating chamber 21a is opened and closed. At this time, a vacuum tightness of abutting surfaces of the vacuum chamber 2, the connecting flange 21f and the shutter member 7 is maintained by means of a sealing member 23. The connecting flange 21f is a connecting portion for connecting the atomic hydrogen discharging port 21b to the treating chamber 3 in the vacuum tightness. The shutter member 7 and the shutter opening/closing driving mechanism 8 serve as opening and closing means for opening and closing the communicating port between the treating chamber 3 and the generating chamber 21a.

More specifically, with the structure, the atomic hydrogen generator 11 includes the container 21 having the generating chamber 21a for generating the atomic hydrogen therein and provided with the exhaust port for evacuating the generating chamber 21a, the gas introducing port for introducing the hydrogen gas into the generating chamber 21a, the atomic hydrogen discharging port 21b for feeding the generated atomic hydrogen to the treating chamber 3, and the connecting portion for connecting the atomic hydrogen discharging port 21b to the treating chamber 3 in the vacuum tightness, and the heat generator attached removably to the inner part of the generating chamber 21a and serving to generate the atomic hydrogen from the hydrogen gas by causing the hydrogen gas to come in contact therewith in a heat generating state. In the embodiment, the supply and exhaust port 21c has such a configuration as to serve as an exhaust port for evacuating the generating chamber 21a and a gas introducing port for introducing the hydrogen gas into the generating chamber 21a.

A view port 21e is provided on an upper surface of the container 21, and the heat generating state of the tungsten heater 25 in the heater cassette 12 can be visually observed from an outside through the view port 21e in a state in which the heater cassette 12 is inserted in the generating chamber 21a. Alternatively, the heat generating state of the tungsten heater 25 can be detected by a non-contact type temperature sensor such as a pyrometer. More specifically, the container 21 is provided with an opening for observation through which the tungsten heater 25 attached into the generating chamber 21a can be observed from an outside.

Description will be given to the structure of the heater cassette 12. As shown in FIGS. 4 and 5(b), the disc-shaped attaching member 26 to be attached to the cassette inserting port 21d is provided with a base portion 26a capable of holding one end side of each of the filament-shaped tungsten heaters 25 in a ring arrangement. An end plate 31 capable of holding one end side of the tungsten heater 25 in the ring arrangement is coupled to the base portion 26a through a spacer 32, and the tungsten heaters 25 are wired in the ring arrangement between the base portion 26a and the end plate 31. The end plate 31 is an annular plate member having a vent opening 31a provided on a center thereof, and a collecting portion 30 extended toward the atomic hydrogen discharging port 21b side is provided integrally with a side surface of the end plate 31. The collecting portion 30 has such a structure that a plurality of collecting plates 30b is disposed in a cylindrical outer casing member 30a with a small clearance maintained, and can be freely attached to and removed from the end plate 31.

With the structure, in the embodiment, the tungsten heater 25 to be the heat generator can be exchangeably attached to the atomic hydrogen generator 11. The tungsten heater 25 is held by the attaching member 26 which can be attached to the cassette inserting port 21d to be a heat generator attaching port provided in the container 21 so that the heater cassette 12 to be the heating unit is formed. The heater cassette 12 has such a configuration as to be inserted from an outside into the generating chamber 21a through the cassette inserting port 21d and to be thus attached thereto.

In the operating state of the atomic hydrogen generator 111 the hydrogen gas introduced from the supply and exhaust port 21c comes in contact with the tungsten heater 25 in the heat generating state so that the hydrogen gas in a molecular state is separated and is changed into atomic hydrogen by a catalyst effect. The atomic hydrogen thus generated flows to the atomic hydrogen discharging port 21b through the vent opening 31a and the collecting portion 30, and furthermore, is discharged into the treating chamber 3 through the opening portion 2c for introduction. At this time, a particle obtained by gasifying an organic matter to be a stuck contaminant or a particle obtained by diffusing tungsten from the surface of the tungsten heater 25 through the heating is generated from the surface of the tungsten heater 25 in a heat generating state, and is discharged together with the atomic hydrogen. The particulates are foreign matters which stick to the surface of the treating object 5, thereby causing a contamination. It is desirable that the particulates should be carried into the treating chamber 3 as rarely as possible in the atomic hydrogen treatment.

In the embodiment, therefore, when the particulate foreign matters pass through the inner part of the clearance of the collecting portion 30 together with the atomic hydrogen, only the particulate foreign matters are stuck to the surface of a collecting plate 31b and are thus collected. Due to the accumulation of a time required for a treating work, a contaminant is deposited and stuck to the collecting portion 30 so that a dirt is generated. For this reason, it is necessary to periodically exchange the collecting portion 30 for a new one. Herein, the collecting portion 30 is constituted removably from the end plate 31 by means of an engaging mechanism (not shown). In the heater cassette 12 to be a consumable component by itself, furthermore, it is possible to exchange only the collecting portion 30 depending on a state of the dirt.

More specifically, in the embodiment, the heater cassette 12 has such a structure as to integrally have the collecting portion 30 for collecting the particulate matter discharged from the surface of the tungsten heater 25. The collecting portion 30 is provided removably from the heater cassette 12. In a state in which the heater cassette 12 is inserted into the generating chamber 21a through the cassette inserting port 21d, the collecting portion 30 is constituted to be positioned between the tungsten heater 25 and the atomic hydrogen discharging port 21b. By causing the atomic hydrogen generator 11 to have the structure, it is possible to easily exchange the consumable components such as the tungsten heater 25 and the collecting portion 30 with a high workability. Thus, it is possible to implement an atomic hydrogen generator which can easily be handled in a maintenance and is excellent in a general purpose.

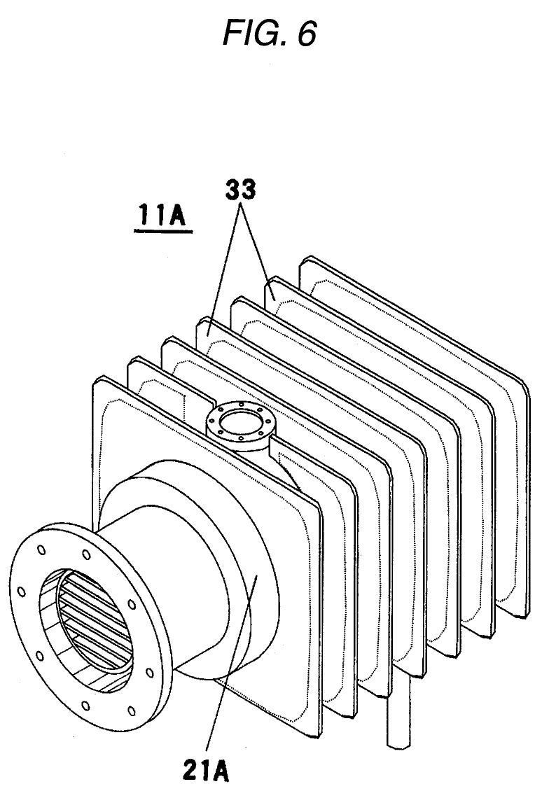

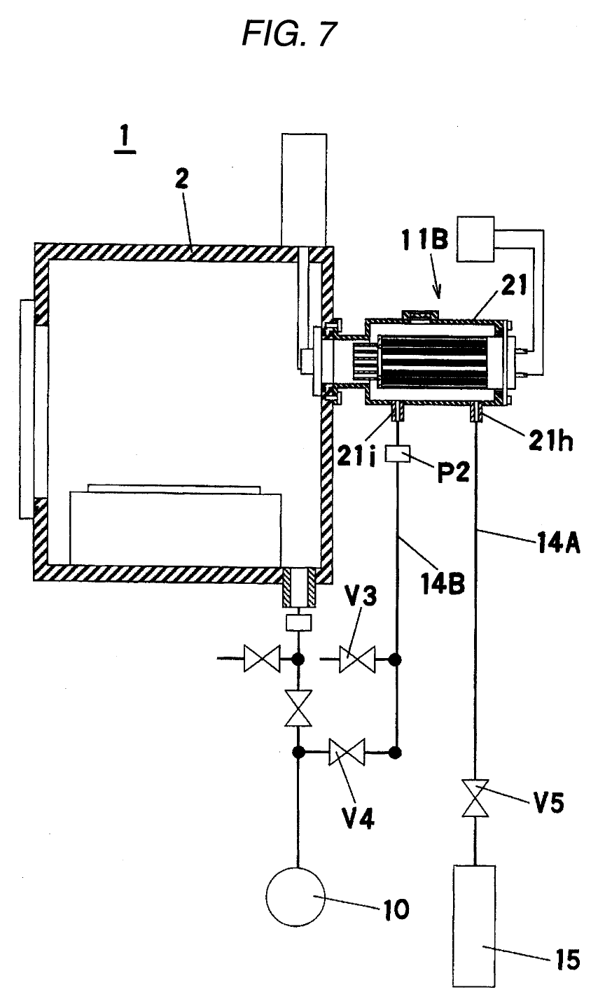

As in an atomic hydrogen generator 11A shown in FIG. 6, it is also possible to provide a plurality of radiating fins 33 on an external surface of a container 21A. Consequently, it is possible to prevent a temperature of the whole container from being excessively raised by the generation of heat of the tungsten heater 25. As in an atomic hydrogen generator 11B shown in FIG. 7, moreover, it is also possible to provide, in the container 21, a special port for each function of air intake and exhaust. In other words, an air intake port 21h and an exhaust port 21i are provided in place of the supply and exhaust port 21c shown in FIG. 1, and a conduit 14A for supplying the hydrogen gas from the hydrogen gas supply 15 is connected to the air intake port 21h and a conduit 14B for carrying out an evacuation by means of the evacuator 10 is connected to the exhaust port 21i.

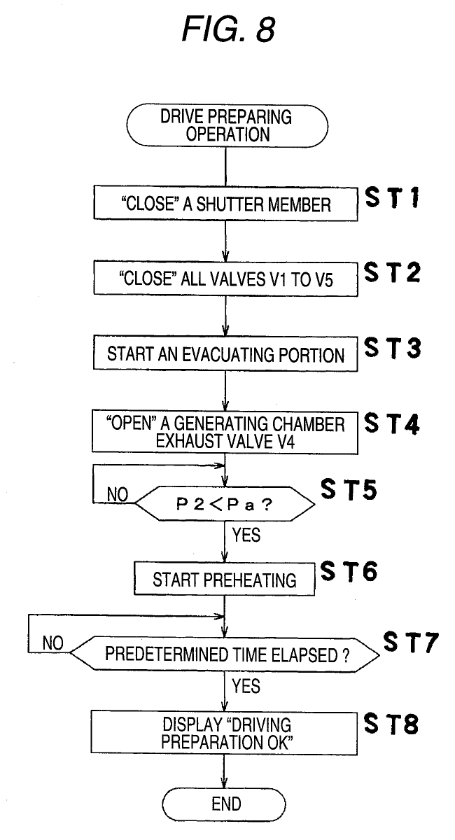

With reference to FIGS. 8, 9 and 10, next, description will be given to the drive preparing operation, the treating operation and the drive stopping operation to be executed when the surface treating work for the treating object 5 is carried out by the surface treating apparatus using atomic hydrogen 1. Each of the operations is executed by an automatic control of each portion in accordance with an operation program in which the controller 20 is built in.

First of all, the drive preparing operation will be described. In FIG. 8, the shutter member 7 is closed (ST1), and subsequently, all of the valves V1 to V5 are closed (ST2). Consequently, an initial state before the start of the driving operation is brought. Then, the evacuator 10 is driven (ST3), and thereafter, the generating chamber exhaust valve V4 is opened (ST4). Consequently, the inner part of the generating chamber 21a is evacuated in the atomic hydrogen generator 11. By the exhausting operation, the pressure detection signal of the pressure sensor 2 is monitored (ST5). When a detection value P2 is smaller than a pressure set value Pa which is preset, that is, the tungsten heater 25 is decompressed in such a manner that a deterioration is not advanced by an oxidation even if the tungsten heater 25 is brought into a heat generating state, preheating is started (ST6) and the power supply 13 is turned ON to cause the tungsten heater 25 to generate heat.

Subsequently, the passage of a predetermined time is waited (ST7). If the temperature is raised to a preset temperature range, “Driving preparation OK” is displayed (ST8). Consequently, the drive preparing operation is ended so that a working operation for the surface treatment of the treating object 5 is enabled. Then, the treating object 5 is delivered into the treating chamber 3 and is mounted on the mounting table 4 so that the surface treatment is executed by the atomic hydrogen.

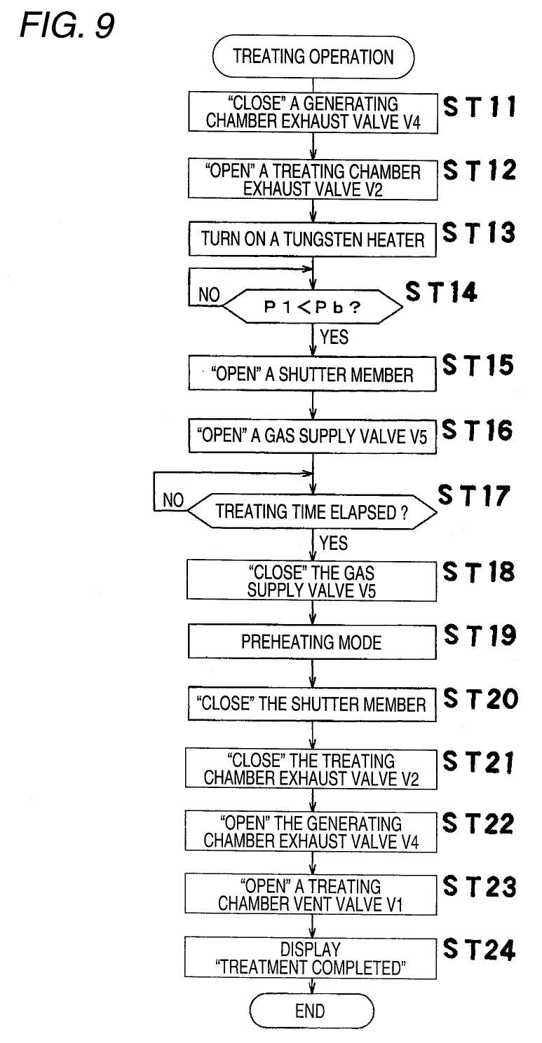

Next, the treating operation will be described. The treating operation is executed in accordance with a treatment starting command sent from the operating and inputting portion 19. In FIG. 9, the generating chamber exhaust valve V4 is closed (ST11). Consequently, the evacuation intended for the inner part of the generating chamber 21a is stopped. Subsequently, the treating chamber exhaust valve V2 is opened (ST12). Consequently, the evacuation in the treating chamber 3 is started. Then, the power supply 13 is driven to turn ON the tungsten heater (ST13). Thereafter, a result of the detection of the pressure sensor P1 is monitored (ST14). If a detection value P1 is reduced beyond a pressure set value Pb, the shutter opening/closing driving mechanism 8 is driven to open the shutter member 7 (ST15). The pressure set value Pb is set to be equal to or smaller than the pressure set value Pa in the drive preparing operation.

Next, the hydrogen gas supply valve V5 is opened (ST16) to start the supply of the hydrogen gas into the generating chamber 21a. Consequently, the hydrogen gas comes in contact with the tungsten heater 25 in the heat generating state so that the atomic hydrogen is generated in the generating chamber 21a. The atomic hydrogen thus generated is discharged into the treating chamber 3 through the opening portion 2c for introduction. The atomic hydrogen comes in contact with the surface of the treating object 5 so that the surface treatment is executed by the atomic hydrogen treatment. Then, the passage of a predetermined treating time is waited (ST17) and the hydrogen gas supply valve V5 is closed (ST18). Consequently, the supply of the hydrogen gas is stopped and the discharge of the atomic hydrogen into the treating chamber 3 is stopped.

Thereafter, the power supply 13 is set into a preheating mode (ST19) and a heat generating temperature of the tungsten heater 25 is reduced, and subsequently, the shutter member 7 is closed (ST20). Consequently, the communicating state of the treating chamber 3 and the generating chamber 21a is blocked. If the treating chamber exhaust valve V2 is closed (ST21) and the generating chamber exhaust valve V4 is opened (ST22), and furthermore, the treating chamber vent valve V1 is opened (ST23), then, “Treatment completed” is displayed (ST24) and the treating operation is ended.

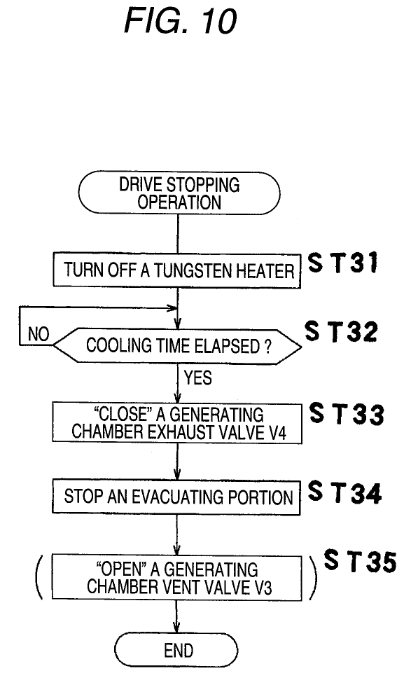

Thereafter, the drive stopping operation is executed. More specifically, in FIG. 10, the tungsten heater is turned OFF (ST31). Subsequently, the passage of a cooling time is waited (ST32). If the tungsten heater 25 is cooled down to such a temperature that a deterioration is not caused by an exposure to oxygen, the generating chamber exhaust valve V4 is closed (ST33). Then, the operation of the evacuator 10 is stopped (ST34), and furthermore, the generating chamber vent valve V3 is opened to bring the generating chamber 21a into an openable state if necessary in respect of a maintenance work, for example, an exchange of the heater cassette 12 in the atomic hydrogen generator 11 (ST35). If the generating chamber 21a does not need to be opened, the pressure reducing state in the generating chamber 21a is held with the generating chamber vent valve V3 closed. Consequently, the drive stopping operation is ended.

In the serial operation, each of the portions is controlled in accordance with the treating program in which the controller 20 is built in. Consequently, an automatic control is carried out in such a manner that the shutter member 7 for opening and closing the opening portion 2c for introducing the atomic hydrogen is closed when the treating chamber 3 is set in a normal pressure state, and the shutter member 7 is opened when the treating chamber 3 is set in the pressure reducing state. In a process for repetitively executing the operation for causing the tungsten heater 25 to generate heat and generating the atomic hydrogen, consequently, the tungsten heater 25 is turned ON in only the state in which the pressure in the treating chamber 21a is reduced. Thus, it is possible to prevent a deterioration from being caused by the heat generation in a state in which the tungsten heater 25 is exposed to the air. The control processing may be executed by manually carrying out an operation input through a manual operating switch provided in the operating and inputting portion 19.

As described above, the surface treating apparatus using atomic hydrogen according to the embodiment employs a structure in which the treating chamber for accommodating the treating object and the generating chamber for generating the atomic hydrogen by causing the hydrogen gas to come in contact with the tungsten heater which is built in are freely opened and closed by the opening and closing means. Consequently, it is possible to maintain the generating chamber in the pressure reducing state irrespective of the state of the treating chamber in the atomic hydrogen generator, thereby continuously holding the conduction of the tungsten heater in the heat generating state. Accordingly, it is possible to eliminate a waiting time for raising the temperature of the heat generator and cooling the heat generator. Thus, it is possible to enhance a treatment efficiency in the atomic hydrogen treatment.

The surface treating apparatus using atomic hydrogen according to the invention has an advantage that a treatment efficiency for atomic hydrogen can be enhanced and is useful for carrying out a surface treatment for a treating object, for example, a surface modification to be executed prior to resin sealing for a substrate on which an element is mounted.

This application is based upon and claims the benefit of priorities of Japanese Patent Application Nos. 2006-184055 and 2006-184056 both filed on Jul. 4, 2006 the contents of which are incorporated herein by reference in its entirety.

What is claimed is:

1. A surface treating apparatus using atomic hydrogen for causing atomic hydrogen to come in contact with a treating object, thereby carrying out a surface treatment for the treating object, comprising:
a treating chamber for accommodating the treating object;
an atomic hydrogen generator having a generating chamber provided to be commutable with the treating chamber and serving to cause a hydrogen gas to come in contact with a heat generator in the generating chamber, thereby-generating atomic hydrogen;
a hydrogen gas supply for supplying the hydrogen gas to the generating chamber,
opening and closing means for opening and closing a communicating port between the treating chamber and the generating chamber;
an evacuator for individually reducing pressures in the treating chamber and the generating chamber; and
a controller for controlling the heat generator, the opening and closing means, and the evacuator.

2. The surface treating apparatus using atomic hydrogen according to claim 1, wherein the heat generator is exchangeably attached to the atomic hydrogen generator.

3. The surface treating apparatus using atomic hydrogen according to claim 1, wherein the controller carries out an automatic control for closing the opening and closing means when the treating chamber is set in a normal pressure state and opening the opening and closing means when the treating chamber is set in a pressure reducing state.

4. The surface treating apparatus using atomic hydrogen according to claim 1, wherein the atomic hydrogen generator comprises:
a container having the generating chamber therein and including an exhaust port for connecting the generating chamber to the evacuator, a gas introducing port for connecting the generating chamber to the hydrogen gas supply, an atomic hydrogen discharging port for feeding the atomic hydrogen generated in the generating chamber to the treating chamber, and a connecting portion for connecting the atomic hydrogen discharging port to the communicating port in a vacuum tightness, and
a heat generator attached removably to an inner part of the generating chamber and serving to generate the atomic hydrogen from the hydrogen gas by causing the hydrogen gas to come in contact therewith in a heat generating state.

5. The surface treating apparatus using atomic hydrogen according to claim 4, wherein the heat generator is held by an attaching member which can be attached to an attaching port of the heat generator which is provided in the container, thereby forming a heating unit, and the heating unit is inserted and attached from an outside into the generating chamber through the heat generator attaching port.

6. The surface treating apparatus using atomic hydrogen according to claim 5, wherein the heating unit integrally includes a collecting portion for collecting a particulate discharged from a surface of the heat generator.

7. The surface treating apparatus using atomic hydrogen according to claim 6, wherein the collecting portion is provided removably from the heating unit.

8. The surface treating apparatus using atomic hydrogen according to claim 6, wherein the collecting portion is positioned between the heat generator and the atomic hydrogen discharging port in a state in which the heating unit is inserted into the generating chamber through the heat generator attaching port.

9. The surface treating apparatus using atomic hydrogen according to claim 4, wherein the container is provided with an opening for observation through which the heat generator attached into the atomic hydrogen generating chamber can be observed from an outside.

10. The surface treating apparatus using atomic hydrogen according to claim 4, wherein the exhaust port serves as the gas introducing port.
